(19) United States
(12) Patent Application Publication
(10) Pub. No.: US 2004/0055714 A1
(43) Pub. Date: Mar. 25, 2004

(54) Blind slat and its fabrication method

(75) Inventor: Ming Nien, Changhua Hsien (TW)

Correspondence Address: BACON & THOMAS, PLLC, 625 SLATERS LANE, FOURTH FLOOR, ALEXANDRIA, VA, 22314

(73) Assignee: NIEN MADE ENTERPRISE CO., LTD., Changhua Hsien (TW)

(21) Appl. No.: 10/246,532

(22) Filed: Sep. 19, 2002

(51) Int. Cl. E06B 3/12

(52) U.S. Cl. 160/236

(57) ABSTRACT

A blind slat is constructed having a center core of wooden slat, a layer of water based colorant coated on the surface of the center core of wooden slat and dried by means of the radiation of infrared rays, a layer of water based base paint coated on the surface of the layer of water based colorant and dried by means of the radiation of infrared rays, and a layer of water based face paint coated on the surface of the layer of base paint and dried by means of the radiation of infrared rays.

### BACKGROUND OF THE INVENTION

1. Field of the Invention

The present invention relates to wooden slats for blinds and, more specifically, to a blind slat fabrication method and the products made subject to the method.

2. Description of the Related Art

The slats for conventional blinds are commonly made of polycarbonate or aluminum. The fabrication of polycarbonate or aluminum slats tends to cause environmental pollution. Nowadays, wooden and bamboo materials are commonly used for making slats for blinds. When making wooden slats for blinds, row wooden slats are treated through a series of processes including sterilizing, embalming and dehydrating processing procedures, and then coated with a layer of oil base paint and a layer of oil face paint. This wooden slat fabrication method has the drawings as follows:

1. The oil base and face paints produce a sticky bad smell that is harmful to the health.

2. The oil base and face paints contain a solvent that is harmful to the environment.

3. It takes much time to dry the coating with currents of air from air blower means after coating of the oil base paint of oil face paint.

4. In order to shorten the coating drying time, the conveying passage is prolonged and the number of air blower devices is relatively increased, resulting in high equipment installation cost and space occupation.

### SUMMARY OF THE INVENTION

It is the main object of the present invention to provide a blind slat fabrication method, which uses water based paints instead of oil paints, reducing the possibility of damaging the environment during the blind slat fabrication procedure.

It is another object of the present invention to provide a blind slat fabrication method, which employs far infrared rays to dry the coatings, so as to shorten the coating drying time and improve the blind slat processing efficiency.

It is still another object of the present invention to provide a blind slat fabrication method, which greatly reduces the coating equipment investment cost and installation space.

To achieve these objects of the present invention, the blind slat fabrication method comprises the steps of: a) delivering prepared raw wooden slats toward a predetermined location; b) coating said prepared raw wooden slats a layer of water based base paint and then drying the wooden slats thus obtained by means of the radiation of far infrared rays; c) coating the base paint-coated wooden slats thus obtained from said step b) a layer of water based face paint and then drying the wooden slats thus obtained by means of the radiation of far infrared rays; and d) collecting the face paint-coated wooden slats when dried. Further a colorant coating sub-step may be employed after step a) and before step b) to coat the prepared raw wooden slats with a layer of water based colorant and then to dry the colorant coated wooden slats by means of the radiation of far infrared rays.

### BRIEF DESCRIPTION OF THE DRAWINGS

FIG. 1 is a flow chart explaining the procedure of the colorant coating step according to the present invention.

FIG. 2 is a flow chart explaining the procedure of the base paint coating step according to the present invention.

FIG. 3 is a flow chart explaining the procedure of the face paint coating step according to the present invention.

FIG. 4 is a sectional view of a blind slat constructed according to the present invention.

### DETAILED DESCRIPTION OF THE PREFERRED EMBODIMENT

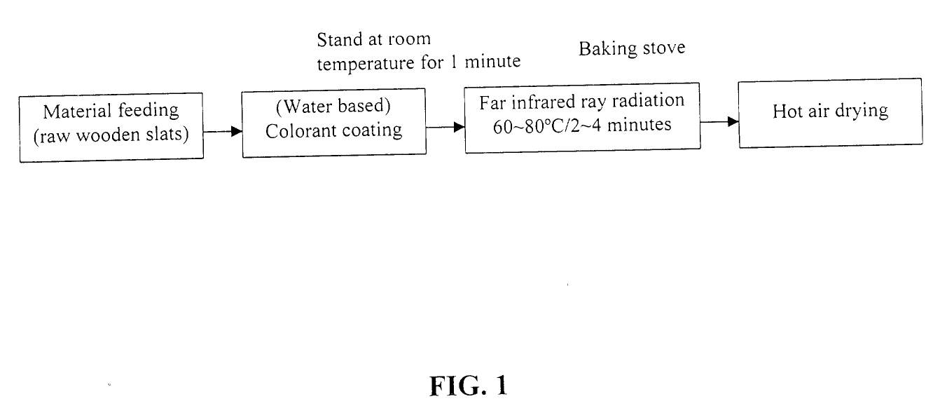

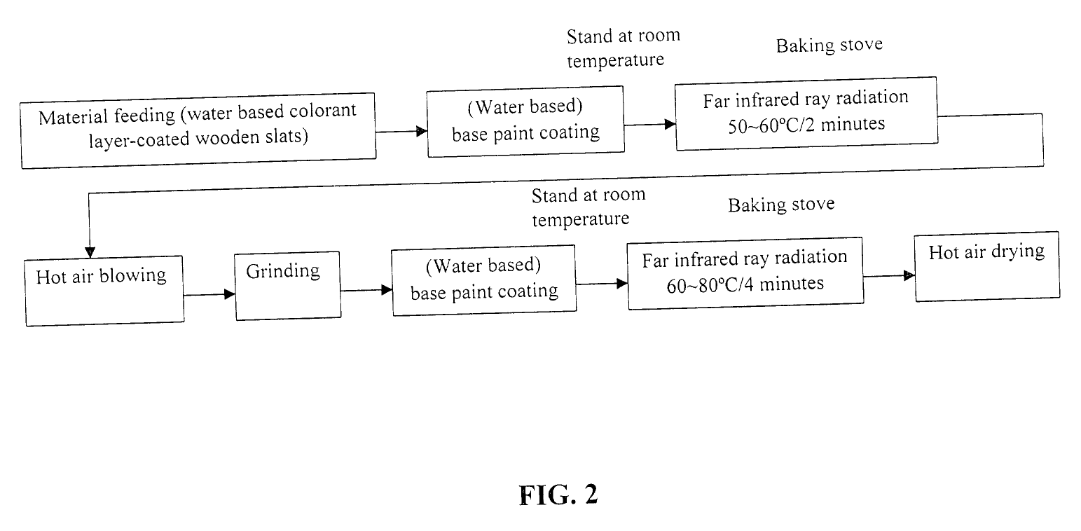

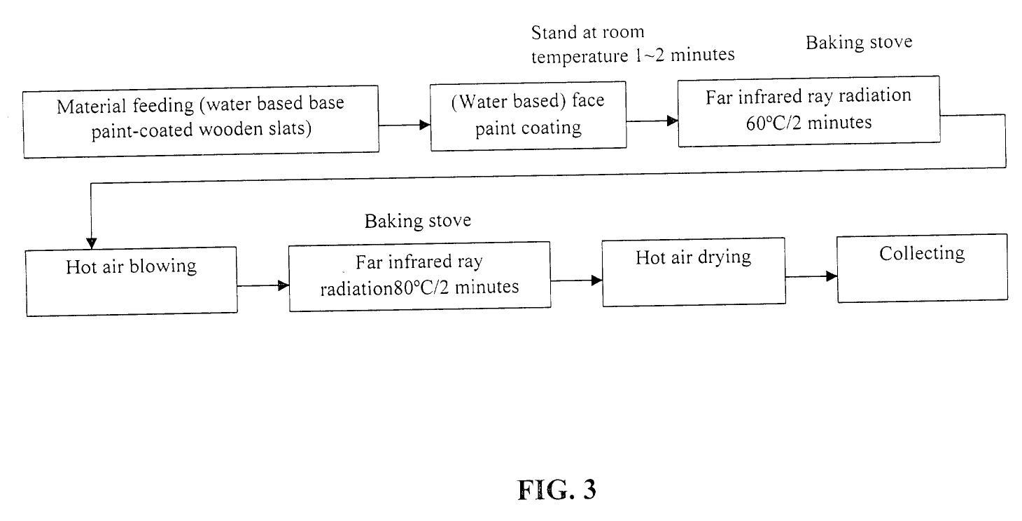

Referring to FIGS. 1-3, a blind slat fabrication method in accordance with the present invention is to spray-paint raw wooden slats having treated through sterilizing, embalming and dehydrating processing procedures into finished vermin-proof and weather-proof slats. The spray-painting procedure is applicable to raw slats without wood grain. The procedure includes steps as follows:

A. Material Feeding:

At first, deliver prepared raw wooden slats having no wood grain toward the predetermined location;

B. Colorant Coating:

Spray-coat the surface of each raw wooden slat delivered subject to Step A with a water based colorant, forming a layer of colorant coating, and then keep the colorant-coated wooden slats at room temperature for one minute for enabling the base coating to be stabilized, and then heat the colorant-coated wooden slats to a dray status with far infrared rays at temperature within 60° C.˜80° C. for about 2˜4 minutes, and then operate a hot air fan to dry the colorant-coated wooden slats, and thus wooden slats with wood grain are obtained.

C. Base Paint Coating:

Spray-coat the surface of each wooden slat obtained from Step B with a layer of water based transparent base paint, and then keep the base paint-coated wooden slats at room temperature, and then heat the base paint-coated wooden slats to a dray status with far infrared rays at temperature within 50° C.˜60° C. for about 2 minutes, and then operate the hot air fan to dry the base paint-coated wooden slats. During Step C, the initially base paint-coated wooden slats can be treated with a secondary base paint coating procedure where the initially base paint-coated wooden slats are surface-ground, then spray-coated with a layer of water based base paint, and then radiated with far infrared rays at temperature within 60° C.˜80° C. for about 4 minutes and then dried with hot air from the hot air fan.

D. Face Paint Coating:

Spray-coat the surface of each wooden slat obtained from Step C with a layer of water based transparent face paint, and then keep the face paint-coated wooden slats at room temperature for about 1˜2 minutes, and then heat the face paint-coated wooden slats to a dray status with far infrared rays at temperature about 60° C. for about 2 minutes, and then operate the hot air fan to dry the face paint-coated wooden slats. During Step D, the initially face paint-coated wooden slats can be treated with a secondary drying procedure where the initially face paint-coated wooden slats are radiated with far infrared rays at temperature about 80° C. for about 2 minutes and then dried with hot air from the hot air fan.

E. Finishing:

The wooden slats thus obtained from Step D are collected for assembling into the desired blinds.

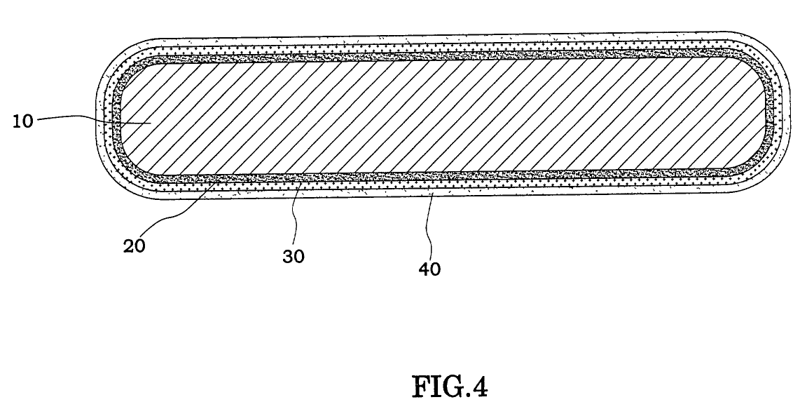

FIG. 4 is a cross sectional view of a blind slat made according to the aforesaid fabrication method. As illustrated, the blind slat comprises a center core of wooden slat 10, a colorant layer 20 coated on the surface of the wooden slat 10, a layer of base paint 30 coated on the surface of the colorant layer 20, and a layer of face paint 40 coated on the surface of the layer of base paint 30.

The water based base paint used during the aforesaid Step C preferably contains about 85% acrylic emulsion binder, 0.1% ammonia, 5% deionized water, 1˜3% zinc stearate, 2˜5% butyl-glycol, 2˜5% dispersant, 0.3% defoamer, 0.3% fungicidal agent, and 0.3% thickener. The water based face paint used during the aforesaid Step D preferably contains about 95% copolymer of acrylic polyurethane, 0.1% triethylamine, 4% deionized water, 1% butyl-glycol, 0.1% wetting agent, 0.1% fungicidal agent, 0.1˜0.3% thickener, and 0.1˜0.3% defoamer.

As indicated above, the invention has the advantages as follows:

1. The use of far infrared rays to dray the coating after each coating procedure greatly shortens the drying time, improves the processing efficiency, and eliminates the drawbacks of high equipment space occupation and long drying time as encountered in conventional methods.

2. Due to long wavelength an low energy, the use of far infrared rays to dry the coating after each coating procedure eliminates the risk of burning the skin and the eyes of the operators accidentally as seen in conventional methods of using infrared rays.

3. Because water based paints are used, during the process of each coating procedure does not produce any sticky bad smell or solvent harmful to the environment.

4. During colorant coating, the user can coat raw wooden slats with the desired color of water based colorant, so that the desired color is well shown after the coating of the layer of transparent base paint and the layer of transparent face paint.

Further, the step of colorant coating can be eliminated if raw wooden slats having a wood grain are used, i.e., transparent base paint and face paint are directly coated on raw wooden slats having a wood grain, enabling the finished blind slats to show the original wild wood grain of the wood.

What the invention claimed is:

1. A blind slat fabrication method comprising the steps of:
a) delivering prepared raw wooden slats toward a predetermined location;
b) respectively coating said prepared raw wooden slats a layer of water based base paint and then drying the wooden slats thus obtained by means of the radiation of far infrared rays;
c) respectively coating the base paint-coated wooden slats thus obtained from said step b) a layer of water based face paint and then drying the wooden slats thus obtained by means of the radiation of far infrared rays; and
d) collecting the face paint-coated wooden slats when dried.

2. The blind slat fabrication method as claimed in claim 1, further comprising a colorant coating sub-step after said step a) and before said step b) to coat said prepared raw wooden slats with a layer of water based colorant and then to dry the colorant coated wooden slats by means of the radiation of far infrared rays.

3. The blind slat fabrication method as claimed in claim 2, wherein said colorant coated wooden slats are dried with far infrared rays at temperature within 60° C.˜80° C. for about 2˜4 minutes.

4. The blind slat fabrication method as claimed in claim 1, wherein said layer of water based base paint is dried, during said step b), by far infrared rays at temperature within 50° C.˜60° C. for about 2 minutes.

5. The blind slat fabrication method as claimed in claim 4, where said step b) further comprising a sub-step of grinding the base paint-coated wooden slats after drying of said layer of water based base paint, and then coating the surface of the base paint-coated wooden slats with a layer of water based base paint and drying the layer of water based base paint with far infrared rays.

6. The blind slat fabrication method as claimed in claim 5, wherein the radiation of far infrared rays is controlled at 60° C.˜80° C. for about 4 minutes during the sub-step of said step b).

7. The blind slat fabrication method as claimed in claim 1, wherein the face paint coated wooden slats are dried with far infrared rays at temperature within 60° C. for about 2 minutes during said step c).

8. The blind slat fabrication method as claimed in claim 7, wherein the face-paint coated wooden slats are dried again by hot air after the radiation of far infrared rays, and then radiated by far infrared rays again at temperature about 80° C. for about 2 minutes.

9. The blind slat fabrication method as claimed in claim 1, wherein said water based base paint contains about 85% acrylic emulsion binder, 0.1% ammonia, 5% deionized water, 1˜3% zinc stearate, 2˜5% butyl-glycol, 2˜5% dispersant, 0.3% defoamer, 0.3% fungicidal agent, and 0.3% thickener.

10. The blind slat fabrication method as claimed in claim 1, wherein said water based face paint contains about 95% copolymer of acrylic polyurethane, 0.1% triethylamine, 4% deionized water, 1% butyl-glycol, 0.1% wetting agent, 0.1% fungicidal agent, 0.1˜0.3% thickener, and 0.1˜0.3% defoamer.

11. A blind slat comprising:
a center core of wooden slat,
a layer of water based base paint coated on the surface of said center core of wooden slat and dried by means of the radiation of infrared rays, and
a layer of water based face paint coated on the surface of said layer of base paint and dried by means of the radiation of infrared rays.

12. The blind slat as claimed in claim 11 further comprising a colorant layer coated on the surface of said center core of wooden slat and surrounded by said layer of base paint.
